(19) United States
(12) Patent Application Publication
(10) Pub. No.: US 2020/0277870 A1
(43) Pub. Date: Sep. 3, 2020

(54) Axial Flow Turbine

(71) Applicant: Mitsubishi Hitachi Power Systems, Ltd., Yokohama-shi (JP)

(72) Inventors: Shigeki SENOO, Tokyo (JP); Kazuhiro MOMMA, Yokohama (JP)

(21) Appl. No.: 16/719,130

(22) Filed: Dec. 18, 2019

(30) Foreign Application Priority Data
Feb. 28, 2019 (JP) 2019-035932

(51) Int. Cl. F01D 9/04; F01D 5/02

(52) U.S. Cl. CPC F01D 9/041; F01D 5/021; F05D 2240/12; F05D 2240/24; F05D 2220/30

(57) ABSTRACT

To provide an axial flow turbine that can reduce interference loss and secondary flow loss, and can reduce mixing loss. An axial flow turbine includes: stator blades provided on the inner-circumference side of a diaphragm outer ring; a diaphragm inner ring provided on the inner-circumference side of the stator blades; moving blades provided on the outer-circumference side of a rotor; a shroud provided on the outer-circumference side of the moving blades; a main flow path constituted by a flow path formed between an inner circumferential surface of the diaphragm outer ring and an outer circumferential surface of the diaphragm inner ring, and a flow path formed between an inner circumferential surface of the shroud and an outer circumferential surface of the rotor; and a cavity formed between the diaphragm inner ring and the rotor. The outer circumferential surface of the rotor has protruding portions and depressed portions. Each depressed portion extends along a relative flow direction of a working fluid passed through the stator blades in the main flow path.

### BACKGROUND OF THE INVENTION

### 1. Field of the Invention

The present invention relates to an axial flow turbine used for a steam turbine, gas turbine or the like at power plants.

### 2. Description of the Related Art

For example, an axial flow turbine includes: an annular diaphragm outer ring provided on an inner-circumference side of a casing; a plurality of stator blades that are provided on an inner-circumference side of the diaphragm outer ring, and arrayed in a circumferential direction; an annular diaphragm inner ring provided on an inner-circumference side of the plurality of stator blades; a rotor; a plurality of moving blades that are provided on an outer-circumference side of the rotor and arrayed in the circumferential direction; and an annular shroud provided on an outer-circumference side of the plurality of moving blades.

A main flow path of the axial flow turbine is constituted by a flow path formed between an inner circumferential surface of the diaphragm outer ring and an outer circumferential surface of the diaphragm inner ring, and a flow path formed between an inner circumferential surface of the shroud and an outer circumferential surface of the rotor. In the main flow path, the plurality of stator blades, i.e., one stator blade row, are arranged, and the plurality of moving blades, i.e., one moving-blade row, are arranged on the downstream side of the plurality of stator blades. A combination of these stator blades, and moving blades constitutes one stage. Typically, a plurality of stages are provided in the axial direction. It is configured such that working fluid flowing through the main flow path is accelerated and caused to turn by the stator blades, and thereafter applies rotational force to the moving blades.

A first cavity is formed between the diaphragm inner ring and the rotor. Part of the working fluid flows into the first cavity from an upstream side of the stator blades in the main flow path, and flows out of the first cavity to the downstream side of the stator blades in the main flow path. Since the part of the working fluid is neither accelerated nor caused to turn by the stator blades, loss occurs. In order to reduce the loss, the first cavity is provided with a labyrinth seal.

A second cavity is formed between the shroud and the casing or diaphragm outer ring. Part of the working fluid flows into the second cavity from an upstream side of the moving blades in the main flow path, and flows out of the second cavity to a downstream side of the moving blades in the main flow path. Since the part of the working fluid does not apply rotational force to the moving blades, loss occurs. In order to reduce the loss, the second cavity is provided with a labyrinth seal.

JP-2008-248701-A proposes, for example, a structure of the outer circumferential surface of the rotor for reducing pressure loss of a flow flowing from the first cavity toward an inter-blade flow path of moving blades. Explaining specifically, the outer circumferential surface of the rotor has a plurality of protruding portions and a plurality of depressed portions that are arranged alternately in the circumferential direction. Each of the plurality of protruding portions is formed in an area including the upstream edge position of the moving blade in the circumferential direction, and on the upstream side of the upstream edge position of the moving blade in the axial direction. Each of the plurality of depressed portions is positioned between the upstream edges of a pair of moving blades that are adjacent to each other in the circumferential direction, and formed on the upstream side of the upstream edge positions of the moving blades in the axial direction.

### SUMMARY OF THE INVENTION

Meanwhile, for example, while an absolute flow of the working fluid having passed through the stator blades in the main flow path, specifically, a flow relative to the stator's side, has a large circumferential velocity component, an absolute flow of the working fluid flowing out of the first cavity to the main flow path has a small circumferential velocity component. In other words, while a relative flow of the working fluid having passed through the stator blades in the main flow path, specifically, a flow relative to the rotor's side, has a circumferential velocity component in the rotation direction of the rotor, a relative flow of the working fluid flowing out of the first cavity to the main flow path has a circumferential velocity component opposite to the rotation direction of the rotor. Accordingly, mixing loss occurs when the flow from the stator blades and the flow from the first cavity merge. The depressed portions on the outer circumferential surface of the rotor in the invention of JP-2008-248701-A extend in the axial direction, for example, and reduction in the mixing loss mentioned above is not considered therefor.

An object of the present invention is to provide an axial flow turbine that can reduce interference loss, and secondary flow loss and can reduce mixing loss.

In order to achieve an object explained above, a representative aspect of the present invention provides an axial flow turbine including: a diaphragm outer ring provided on an inner-circumference side of a casing; a plurality of stator blades that are provided on an inner-circumference side of the diaphragm outer ring and arrayed in a circumferential direction; a diaphragm inner ring that is provided on an inner-circumference side of the plurality of stator blades; a rotor; a plurality of moving blades that are provided on an outer-circumference side of the rotor and arrayed in the circumferential direction so as to be positioned on a downstream side of the plurality of stator blades; a shroud that is provided on an outer-circumference side of the plurality of moving blades; a main flow path through which a working fluid is distributed, the main flow path being constituted by a flow path formed between an inner circumferential surface of the diaphragm outer ring and an outer circumferential surface of the diaphragm inner ring and a flow path formed between an inner circumferential surface of the shroud and an outer circumferential surface of the rotor; and a cavity into which part of the working fluid flows from an upstream side of the stator blades in the main flow path and out of which the part of the working fluid flows to a downstream side of the stator blades in the main flow path, the cavity being formed between the diaphragm inner ring and the rotor. The outer circumferential surface of the rotor has a plurality of protruding portions and a plurality of depressed portions that are each arranged alternately in the circumferential direction. Each of the plurality of protruding portions is formed in an area including an upstream edge position of the moving blade in the circumferential direction, and including an upstream edge position of the outer circumferential surface of the rotor in an axial direction. Each of the plurality of depressed portions is positioned between upstream edges of moving blades adjacent to each other in the circumferential direction and is formed in an area including the upstream edge position of the outer circumferential surface of the rotor in the axial direction, and extends along a relative flow direction, relative to the rotor, of the working fluid having passed through the stator blades in the main flow path.

According to the present invention, it is possible to reduce interference loss and secondary flow loss, and to reduce mixing loss.

### BRIEF DESCRIPTION OF THE DRAWINGS

FIG. 1 is an axial cross-sectional view schematically representing a partial structure of a steam turbine in a first embodiment of the present invention;

FIG. 2 is a circumferential cross-sectional view which is taken along the cross-section II-II in FIG. 1, and illustrates a flow in a main flow path;

FIG. 3A illustrates a figure representing a difference between a flow on the downstream side of stator blades in a main flow path and a flow on the outlet side of a first cavity, and FIG. 3B is a net drawing representing the structure of an outer circumferential surface of a rotor, in the first embodiment of the present invention;

FIG. 4 is a figure as seen from the direction of the arrow IV in FIG. 3B;

FIG. 5A illustrates a figure representing a difference between a flow on the downstream side of moving blades in a main flow path and a flow on the outlet side of a second cavity, and FIG. 5B is a net drawing representing the structure of an inner circumferential surface of a diaphragm outer ring, in a second embodiment of the present invention; and

FIG. 6 is a figure as seen from the direction of the arrow VI in FIG. 5B.

### DESCRIPTION OF THE PREFERRED EMBODIMENTS

Hereinafter, embodiments of the present invention in cases when the present invention is applied to a steam turbine are explained with reference to the drawings.

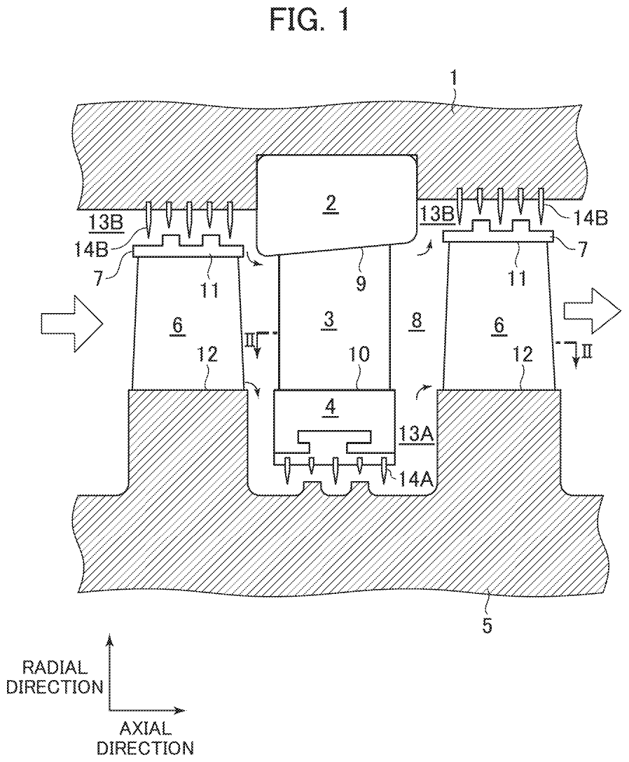

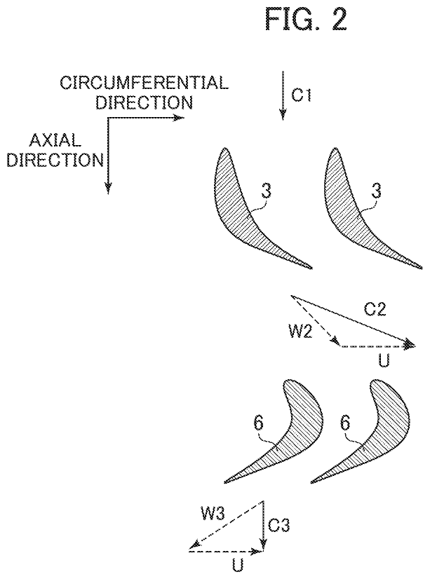

FIG. 1 is an axial cross-sectional view schematically representing a partial structure of a steam turbine in a first embodiment of the present invention. FIG. 2 is a circumferential cross-sectional view which is taken along the cross-section II-II in FIG. 1, and illustrates a flow in a main flow path.

The steam turbine in the present embodiment includes: an annular diaphragm outer ring 2 provided on the inner-circumference side of a casing 1; a plurality of stator blades 3 provided on the inner-circumference side of the diaphragm outer ring 2; and an annular diaphragm inner ring 4 provided on the inner-circumference side of the stator blades 3. The plurality of stator blades 3 are arrayed between the diaphragm outer ring 2 and the diaphragm inner ring 4 at predetermined intervals in the circumferential direction.

In addition, the steam turbine includes: a rotor 5; a plurality of moving blades 6 provided on the outer-circumference side of the rotor 5; and an annular shroud 7 provided on the outer-circumference side of the moving blades 6. The plurality of moving blades 6 are arrayed between the rotor 5 and the shroud 7 at predetermined intervals in the circumferential direction.

A main flow path 8 of the steam turbine is constituted by a flow path formed between an inner circumferential surface 9 of the diaphragm outer ring 2 and an outer circumferential surface 10 of the diaphragm inner ring 4, and a flow path formed between an inner circumferential surface 11 of the shroud 7 and an outer circumferential surface 12 of the rotor 5. That is, the diaphragm outer ring 2 has the inner circumferential surface 9 that interconnects the plurality of stator blades 3 on their outer-circumference side, and constitutes a wall surface of the main flow path 8. The diaphragm inner ring 4 has the outer circumferential surface 10 that interconnects the plurality of stator blades 3 on their inner-circumference side, and constitutes a wall surface of the main flow path 8. The shroud 7 has the inner circumferential surface 11 that interconnects the plurality of moving blades 6 on their outer-circumference side, and constitutes a wall surface of the main flow path 8. The rotor 5 has the outer circumferential surface 12 that interconnects the plurality of moving blades 6 on their inner-circumference side, and constitutes a wall surface of the main flow path 8.

In the main flow path 8, the plurality of stator blades 3, i.e., one stator blade row, are arranged, and the plurality of moving blades 6, i.e., one moving-blade row, are arranged on the downstream side of the plurality of stator blades 3, or on the right side in FIG. 1. A combination of these stator blades 3 and moving blades 6 constitutes one stage. Note that although only moving blades 6 of the first stage, and stator blades 3 and moving blades 6 of the second stage are illustrated in FIG. 1 for convenience, the number of stages provided in the axial direction is typically three or larger in order to collect the internal energy of steam, or working fluid, efficiently.

Steam in the main flow path 8 flows as illustrated by thick arrows in FIG. 1. Then, the internal energy, i.e., pressure energy and the like, of the steam is converted into kinetic energy, i.e., velocity energy, at the stator blades 3, and the kinetic energy of the steam is converted into the rotational energy of the rotor 5 at the moving blades 6. In addition, it is configured such that a power generator, not illustrated, is connected at an end portion of the rotor 5, and the power generator converts the rotational energy of the rotor 5 into electrical energy.

A steam flow, or a main flow, in the main flow path 8 is explained with reference to FIG. 2. Steam flows in from the upstream edge side of the stator blades 3, or from the top side in FIG. 2, with an absolute velocity vector C1, specifically, an absolute flow with almost no circumferential velocity components. Then, when passing through between the stator blades 3, the steam is accelerated, and caused to turn to have an absolute velocity vector C2, specifically, an absolute flow with a large circumferential velocity component, and flows out from the downstream edge side of the stator blades 3, or from the bottom side in FIG. 2. Most parts of the steam having flowed out of the stator blades 3 collide with the moving blades 6 to rotate the rotor 5 at a velocity U. At this time, when passing through the moving blades 6, the steam is decelerated, and caused to turn, and a relative velocity vector W2 turns a relative velocity vector W3. Accordingly, the steam flowing out of the moving blades 6 has an absolute velocity vector C3, specifically, an absolute flow with almost no circumferential velocity components.

With reference again to FIG. 1 mentioned above, a cavity 13A, or a first cavity, is formed between the diaphragm inner ring 4 and the rotor 5. Part of the steam flows into the cavity 13A from the upstream side of the stator blades 3 in the main flow path 8, and flows out of the cavity 13A to the downstream side of the stator blades 3 in the main flow path 8. Since the part of the steam is neither accelerated nor caused to turn by the stator blades 3, loss occurs. In order to reduce the loss, the cavity 13A is provided with a labyrinth seal 14A. The labyrinth seal 14A is constituted, for example, by a plurality of fins provided on the side of the diaphragm inner ring 4, and a plurality of protrusions formed on the side of the rotor 5.

A cavity 13B, or a second cavity, is formed between the shroud 7 and the casing 1. Part of the steam flows into the cavity 13B from the upstream side of the moving blades 6 in the main flow path 8, and flows out of the cavity 13B to the downstream side of the moving blades 6 in the main flow path 8. Since the part of the steam does not apply rotational force to the moving blades 6, loss occurs. In order to reduce the loss, the cavity 13B is provided with a labyrinth seal 14B. The labyrinth seal 14B is constituted, for example, by a plurality of fins provided on the side of the casing 1, and a plurality of protrusions formed on the side of the shroud 7.

Meanwhile, there is typically a circumferential pressure distribution produced on the inlet side of the moving blades 6 in the main flow path 8. Explaining specifically, the static pressure becomes relatively higher in an area in the circumferential direction near the upstream edge of each moving blade 6. Accordingly, a flow to leak out of the main flow path 8 toward the cavity 13A is generated in the area. On the other hand, the static pressure becomes relatively low in an intermediate area between the upstream edges of the moving blades 6 that are adjacent to each other in the circumferential direction. Accordingly, a flow to spout out of the cavity 13A toward the main flow path 8 is generated in the area. Then, due to the difference between the flows in the circumferential direction, interference loss increases. In addition, due to the influence of the difference between the flows mentioned above, secondary flow loss at the moving blades 6 increases.

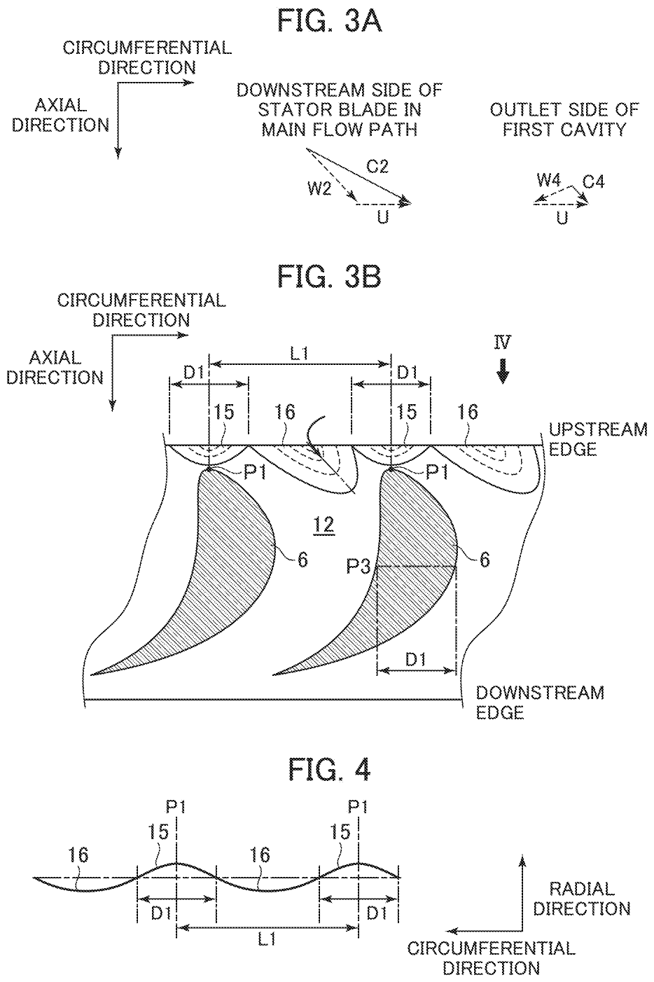

In addition, typically, a steam flow having passed through the stator blades 3 in the main flow path 8 and a steam flow flowing out of the cavity 13A to the main flow path 8 are different. Explaining specifically, steam on the upstream side of the stator blades 3 in the main flow path 8 is an absolute flow with almost no circumferential velocity components as illustrated in FIG. 2, and steam flowing from the main flow path 8 into the cavity 13A is also an absolute flow with almost no circumferential velocity components. However, since the steam is influenced by rotation of the rotor 5 as it flows through the cavity 13A, the steam flowing out of the cavity 13A to the main flow path 8 has an absolute velocity vector C4, specifically, an absolute flow having a small circumferential velocity component, as illustrated in FIG. 3A mentioned below. In other words, the steam flowing out of the cavity 13A to the main flow path 8 has a relative velocity vector W4, specifically, a relative flow having a circumferential velocity component opposite to the rotation direction of the rotor 5.

On the other hand, the steam having passed through the stator blades 3 in the main flow path 8 has an absolute velocity vector C2, specifically, an absolute flow having a large circumferential velocity component, as illustrated in FIG. 2 and FIG. 3A mentioned below. In other words, the steam having passed through the stator blades 3 in the main flow path 8 has a relative velocity vector W2, specifically, a relative flow having a circumferential velocity component in the rotation direction of the rotor 5. Accordingly, mixing loss occurs when the flow from the stator blades 3 and the flow from the cavity 13A merge.

In view of this, in the present embodiment, the outer circumferential surface 12 of the rotor 5 has a structure for reducing the interference loss and secondary flow loss mentioned above, and reducing the mixing loss mentioned above. Details thereof are explained with reference to FIG. 3A, FIG. 3B and FIG. 4. FIG. 3A is a figure representing a difference between a flow on the downstream side of the stator blades in the main flow path and a flow on the outlet side of the first cavity in the present embodiment. FIG. 3B is a net drawing representing the structure of the outer circumferential surface of the rotor in the present embodiment. FIG. 4 is a figure as seen from the direction of the arrow IV in FIG. 3B. Note that dotted lines in FIG. 3B indicate contour lines of protruding portions and depressed portions.

The outer circumferential surface 12 of the rotor 5 in the present embodiment is an approximately cylindrical surface, and has a plurality of protruding portions 15 that protrude radially outward from the cylindrical surface, and a plurality of depressed portions 16 that are depressed radially inward from the cylindrical surface. The protruding portions 15 and depressed portions 16 are each arranged alternately in the circumferential direction.

Each protruding portion 15 is formed in an area including an upstream edge position P1 of the moving blade 6 in the circumferential direction. Explaining specifically, for example, the area has a width equal to the largest width D1 of a moving blade 6, and the center position of the area coincides with the upstream edge position P1 of the moving blade 6. In addition, each protruding portion 15 is formed in an area including the upstream edge position of the outer circumferential surface 12 of the rotor 5 and including only the upstream side of the upstream edge position P1 of the moving blade 6, in the axial direction. In addition, each protruding portion 15 extends along the axial direction.

Each depressed portion 16 is positioned between the upstream edges of a pair of moving blades 6 that are adjacent to each other in the circumferential direction. Explaining specifically, for example, each depressed portion 16 is formed in an area having a width equal to a difference between the inter-blade pitch length L1 and the largest width D1 of a moving blade 6, and the center position of the area is positioned at an intermediate position between the upstream edges of the pair of adjacent moving blades 6. In addition, each depressed portion 16 is formed in an area including: the upstream edge position of the outer circumferential surface 12 of the rotor 5 in the axial direction; and not only the upstream side but also downstream side of the upstream edge positions P1 of the moving blades 6, and not including the downstream side of the positions P3 where the moving blades 6 have the largest width D1.

Due to the protruding portion 15 on the outer circumferential surface 12 of the rotor 5 mentioned above, the width of the main flow path 8 decreases in the area of the protruding portion 15 in the circumferential direction. Thereby, the flow rate of the steam in the area in the circumferential direction rises, and the static pressure lowers. In addition, due to the depressed portion 16 on the outer circumferential surface 12 of the rotor 5 mentioned above, the width of the main flow path 8 increases in the area of the depressed portion 16 in the circumferential direction. Thereby, the flow rate of the steam in the area in the circumferential direction lowers, and the static pressure rises. Accordingly, it is possible to reduce pressure differences in the circumferential direction to reduce differences between flows in the circumferential direction. As a result, interference loss and secondary flow loss can be reduced.

Furthermore, in the present embodiment, each depressed portion 16 extends along a relative flow direction of steam having passed through the stator blades 3 in the main flow path 8, i.e., the direction of the relative velocity vector W2. Explaining specifically, each cross-section of a depressed portion 16 in the circumferential direction has an approximately triangular shape, for example, and a straight line linking the bottoms of individual cross-sections coincides with the relative flow direction of the steam. In addition, each depressed portion 16 is formed to be gradually shallow along the relative flow direction of the steam. Then, steam from the cavity 13A flows along the depressed portions 16 on the outer circumferential surface 12 of the rotor 5 to be thereby caused to turn. In particular, since each depressed portion 16 is formed in an area including, in the axial direction, not only the upstream side but also downstream side of the upstream edge positions P1 of the moving blades 6 in the present embodiment, a sufficient flow turning effect can be attained. Thereby, it is possible to cause the steam from the cavity 13A to turn in the direction of the relative velocity vector W2 to attempt to reduce mixing loss.

Note that although, in the example explained in the first embodiment, each protruding portion 15 is formed in the area with the width equal to the largest width D1 of the moving blade 6 in the circumferential direction, this is not the sole example, and for example each protruding portion 15 may be formed in an area with a width equal to 90% to 110% of the largest width D1 of the moving blade 6 in the circumferential direction. In addition, although, in the example explained in the first embodiment, the center position of each protruding portion 15 in the circumferential direction coincide with the upstream edge position P1 of the moving blade 6, this is not the sole example, and the center position of each protruding portion 15 may not coincide with the upstream edge position P1 of the moving blade 6 as long as each protruding portion 15 is formed in an area including the upstream edge position P1 of the moving blade 6 in the circumferential direction. In addition, although, in the example explained in the first embodiment, each protruding portion 15 extends in the axial direction, this is not the sole example, and similar to each depressed portion 16 each protruding portion 15 may extend along the flow direction, relative to the rotor 5, of the steam having passed through the stator blades 3 in the main flow path 8, i.e., the direction of the relative velocity vector W2.

In addition, although, in the example explained in the first embodiment, the depressed portions 16 are formed to be continuous with the protruding portions 15 in the circumferential direction, this is not the sole example, and the depressed portions 16 may be formed to be not continuous with the protruding portions 15 in the circumferential direction. In addition, although, in the example explained in the first embodiment, each depressed portion 16 is formed in the area including, in the axial direction, not only the upstream side, but also downstream side of the upstream edge positions P1 of the moving blades 6, this is not the sole example. That is, although it becomes not possible to attain a sufficient flow turning effect, each depressed portion 16 may be formed in an area including, in the axial direction, only the upstream side of the upstream edge positions P1 of the moving blades 6.

A second embodiment of the present invention is explained. Note that portions in the present embodiment that are equivalent to those in the first embodiment are given the same signs, and explanations thereof are omitted as appropriate.

There is typically a circumferential pressure distribution produced on the inlet side of the stator blades 3 in the main flow path 8. Explaining specifically, the static pressure becomes relatively higher in an area in the circumferential direction near the upstream edge of each stator blade 3. Accordingly, a flow to leak out of the main flow path 8 toward the cavity 13B is generated in the area. On the other hand, the static pressure becomes relatively low in an intermediate area between the upstream edges of the stator blades 3 that are adjacent to each other in the circumferential direction. Accordingly, a flow to spout out of the cavity 13B toward the main flow path 8 is generated in the area. Then, due to the difference between the flows in the circumferential direction, interference loss increases. In addition, due to the influence of the difference between the flows mentioned before, secondary flow loss at stator blades 3 increases.

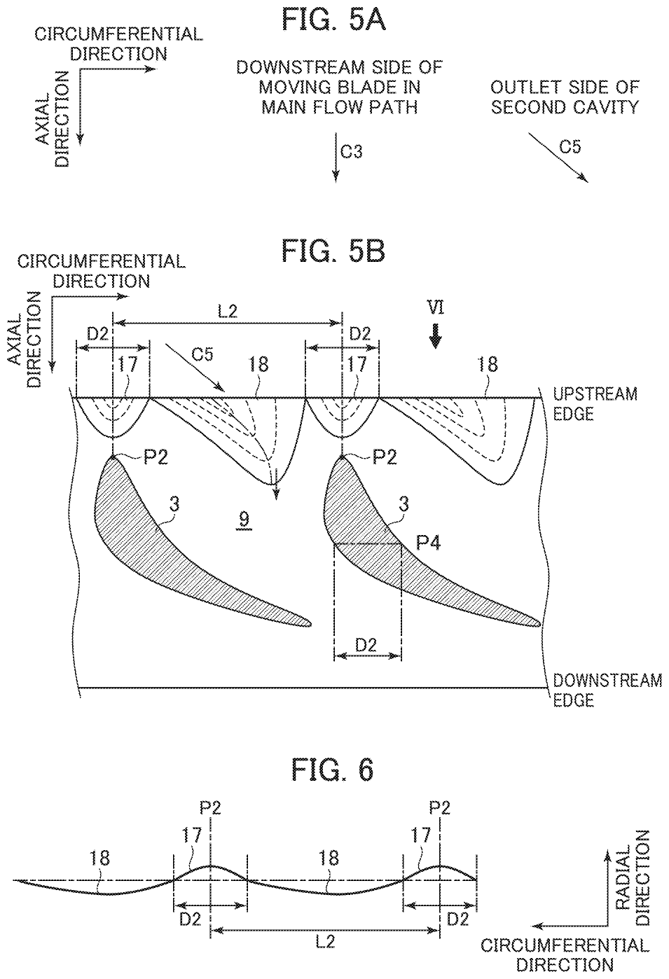

In addition, typically, a steam flow having passed through the moving blades 6 in the main flow path 8, and a steam flow flowing out of the cavity 13B to the main flow path 8 are different from each other. Explaining specifically, steam on the upstream side of the moving blades 6 in the main flow path 8 is an absolute flow with a large circumferential velocity component as illustrated in FIG. 2 mentioned above, and steam flowing from the main flow path 8 into the cavity 13B is also an absolute flow with a large circumferential velocity component. Accordingly, the steam flowing out of the cavity 13B to the main flow path 8 has an absolute velocity vector C5, specifically, an absolute flow having a large circumferential velocity component, as illustrated in FIG. 5A mentioned below. On the other hand, the steam having passed through the moving blades 6 in the main flow path 8 has an absolute velocity vector C3, specifically, an absolute flow with almost no circumferential velocity components, as illustrated in FIG. 2 mentioned above and FIG. 5A mentioned below. Accordingly, mixing loss occurs when the flow from the moving blades 6 and the flow from the cavity 13B merge.

In view of this, in the present embodiment, the inner circumferential surface 9 of the diaphragm outer ring 2 has a structure for reducing the interference loss and secondary flow loss mentioned above, and reducing the mixing loss mentioned above. Details thereof are explained with reference to FIG. 5A, FIG. 5B and FIG. 6.

FIG. 5A is a figure representing a difference between a flow on the downstream side of the moving blades in the main flow path and a flow on the outlet side of the second cavity in the present embodiment. FIG. 5B is a net drawing representing the structure of the inner circumferential surface of the diaphragm outer ring in the present embodiment. FIG. 6 is a figure as seen from the direction of the arrow VI in FIG. 5B. Note that dotted lines in FIG. 5B indicate contour lines of protruding portions and depressed portions.

The inner circumferential surface 9 of the diaphragm outer ring 2 in the present embodiment is an approximately cylindrical surface, and has a plurality of protruding portions 17 that protrude radially inward from the cylindrical surface, and a plurality of depressed portions 18 that are depressed radially outward from the cylindrical surface. The protruding portions 17 and depressed portions 18 are each arranged alternately in the circumferential direction.

Each protruding portion 17 is formed in an area including an upstream edge position P2 of the stator blade 3 in the circumferential direction. Explaining specifically, for example, the area has a width equal to the largest width D2 of a stator blade 3, and the center position of the area coincides with the upstream edge position P2 of the stator blade 3. In addition, each protruding portion 17 is formed in an area including the upstream edge position of the inner circumferential surface 9 of the diaphragm outer ring 2 and only the upstream side of the upstream edge position P2 of the stator blade 3, in the axial direction. In addition, each protruding portion 17 extends along the axial direction.

Each depressed portion 18 is positioned between the upstream edges of a pair of stator blades 3 that are adjacent to each other in the circumferential direction. Explaining specifically, for example, each depressed portion 18 is formed in an area that has a width equal to a difference between the inter-blade pitch length L2 and the largest width D2 of a stator blade 3, and the center position of the area is positioned at an intermediate position between the upstream edges of the pair of adjacent stator blades 3. In addition, each depressed portion 18 is formed in an area including the upstream edge position of the inner circumferential surface 9 of the diaphragm outer ring 2 in the axial direction, and not only the upstream side but also downstream side of the upstream edge positions P2 of the stator blades 3, and not including the downstream side of the positions P4 where the stator blades 3 have the largest width D2.

Due to the protruding portion 17 on the inner circumferential surface 9 of the diaphragm outer ring 2 mentioned above, the width of the main flow path 8 decreases in the area of the protruding portion 17 in the circumferential direction. Thereby, the flow rate of the steam in the area in the circumferential direction rises, and the static pressure lowers. In addition, due to the depressed portion 18 on the inner circumferential surface 9 of the diaphragm outer ring 2 mentioned above, the width of the main flow path 8 increases in the area of the depressed portion 18 in the circumferential direction. Thereby, the flow rate of the steam in the area in the circumferential direction lowers, and the static pressure rises. Accordingly, it is possible to reduce pressure differences in the circumferential direction to reduce differences between flows in the circumferential direction. As a result, interference loss and secondary flow loss can be reduced.

Furthermore, in the present embodiment, each depressed portion 18 extends so as to be gradually curved from the absolute flow direction of steam having flowed out from the cavity 13B, i.e., the direction of the absolute velocity vector C5, toward the absolute flow direction of steam having passed through the moving blades 6 in the main flow path 8, i.e., the direction of the absolute velocity vector C3. Explaining specifically, each cross-section of a depressed portion 18 in the circumferential direction has an approximately triangular shape, for example, and a curved line linking the bottoms of individual cross-sections changes from the direction of the absolute velocity vector C5 toward the direction of the absolute velocity vector C3. In addition, each depressed portion 18 is formed to be gradually shallow along the curved line mentioned before. Then, steam from the cavity 13B flows along the depressed portions 18 on the inner circumferential surface 9 of the diaphragm outer ring 2 to be thereby caused to turn. In particular, since each depressed portion 18 is formed in an area including, in the axial direction, not only the upstream side but also downstream side of the upstream edge positions P2 of the stator blades 3 in the present embodiment, a sufficient flow turning effect can be attained. Thereby, it is possible to cause the steam from the cavity 13B to turn in the direction of the absolute velocity vector C3 to attempt to reduce mixing loss.

Note that although, in the example explained in the second embodiment, each protruding portion 17 is formed in the area with the width equal to the largest width D2 of the stator blade 3 in the circumferential direction, this is not the sole example, and for example each protruding portion 17 may be formed in an area with a width equal to 90% to 110% of the largest width D2 of the stator blade 3 in the circumferential direction. In addition, although, in the example explained in the second embodiment, the center position of each protruding portion 17 in the circumferential direction coincide with the upstream edge position P2 of the stator blade 3, this is not the sole example, and the center position of each protruding portion 17 may not coincide with the upstream edge position P2 of the stator blade 3 as long as each protruding portion 17 is formed in an area including, in the circumferential direction, the upstream edge position P2 of the stator blade 3. In addition, although, in the example explained in the second embodiment, each protruding portion 17 extends in the axial direction, this is not the sole example, and each protruding portion 17 may extend along the absolute flow direction of the steam having passed through the moving blades 6 in the main flow path 8, i.e., the direction of the absolute velocity vector C3.

In addition, although, in the example explained in the second embodiment, the depressed portions 18 are formed to be continuous with the protruding portions 17 in the circumferential direction, this is not the sole example, and the depressed portions 18 may be formed to be not continuous with the protruding portions 17 in the circumferential direction. In addition, although, in the example explained in the second embodiment, each depressed portion 18 is formed in the area including, in the axial direction, not only the upstream side but also downstream side of the upstream edge positions P2 of the stator blades 3, this is not the sole example. That is, although it becomes not possible to attain a sufficient flow turning effect, each depressed portion 18 may be formed in an area including, in the axial direction, only the upstream side of the upstream edge positions P2 of the stator blades 3.

In addition, although in the examples explained in the first and second embodiments, the present invention is applied to a steam turbine, these are not the sole examples. That is, the present invention may be applied to a gas turbine.

What is claimed is:

1. An axial flow turbine comprising:
a diaphragm outer ring provided on an inner-circumference side of a casing;
a plurality of stator blades that are provided on an inner-circumference side of the diaphragm outer ring and arrayed in a circumferential direction;
a diaphragm inner ring that is provided on an inner-circumference side of the plurality of stator blades;
a rotor;
a plurality of moving blades that are provided on an outer-circumference side of the rotor and arrayed in the circumferential direction so as to be positioned on a downstream side of the plurality of stator blades;
a shroud that is provided on an outer-circumference side of the plurality of moving blades;
a main flow path through which a working fluid is distributed, the main flow path being constituted by a flow path formed between an inner circumferential surface of the diaphragm outer ring and an outer circumferential surface of the diaphragm inner ring and a flow path formed between an inner circumferential surface of the shroud and an outer circumferential surface of the rotor; and
a cavity into which part of the working fluid flows from an upstream side of the stator blades in the main flow path and out of which the part of the working fluid flows to a downstream side of the stator blades in the main flow path, the cavity being formed between the diaphragm inner ring and the rotor, wherein
the outer circumferential surface of the rotor has a plurality of protruding portions and a plurality of depressed portions that are each arranged alternately in the circumferential direction,
each of the plurality of protruding portions is formed in an area including an upstream edge position of the moving blade in the circumferential direction, and including an upstream edge position of the outer circumferential surface of the rotor in an axial direction, and
each of the plurality of depressed portions is positioned between upstream edges of moving blades adjacent to each other in the circumferential direction and is formed in an area including the upstream edge position of the outer circumferential surface of the rotor in the axial direction, and extends along a relative flow direction, relative to the rotor, of the working fluid having passed through the stator blades in the main flow path.

2. The axial flow turbine according to claim 1, wherein
each of the plurality of depressed portions is formed in an area including an upstream side of the upstream edge positions of the moving blades in the axial direction.

3. The axial flow turbine according to claim 2, wherein
each of the plurality of depressed portions is formed in an area including a downstream side of the upstream edge positions of the moving blades and not including a downstream side of positions where the moving blades have the largest width, in the axial direction.

4. An axial flow turbine comprising:
a diaphragm outer ring provided on an inner-circumference side of a casing;
a plurality of stator blades that are provided on an inner-circumference side of the diaphragm outer ring and arrayed in a circumferential direction;
a diaphragm inner ring that is provided on an inner-circumference side of the plurality of stator blades;
a rotor;
a plurality of moving blades that are provided on an outer-circumference side of the rotor and arrayed in the circumferential direction so as to be positioned on an upstream side of the plurality of stator blades;
a shroud that is provided on an outer-circumference side of the plurality of moving blades;
a main flow path that is constituted by a flow path formed between an inner circumferential surface of the diaphragm outer ring and an outer circumferential surface of the diaphragm inner ring and a flow path formed between an inner circumferential surface of the shroud and an outer circumferential surface of the rotor; and
a cavity into which part of the working fluid flows from an upstream side of the moving blades in the main flow path and out of which the part of the working fluid flows to a downstream side of the moving blades in the main flow path, the cavity being formed between the shroud and the casing or the diaphragm outer ring, wherein
the inner circumferential surface of the diaphragm outer ring has a plurality of protruding portions and a plurality of depressed portions that are each arranged alternately in the circumferential direction,
each of the plurality of protruding portions is formed in an area including an upstream edge position of the stator blade in the circumferential direction, and including an upstream edge position of the inner circumferential surface of the diaphragm outer ring in an axial direction, and
each of the plurality of depressed portions is positioned between upstream edges of stator blades adjacent to each other in the circumferential direction and is formed in an area including the upstream edge position of the inner circumferential surface of the diaphragm outer ring in the axial direction, and extends so as to be gradually curved from an absolute flow direction of the working fluid having flowed out of the cavity toward an absolute flow direction of the working fluid having passed through the moving blades in the main flow path.

5. The axial flow turbine according to claim 4, wherein
each of the plurality of depressed portions is formed in an area including an upstream side of the upstream edge positions of the stator blades in the axial direction.

6. The axial flow turbine according to claim 5, wherein
each of the plurality of depressed portions is formed in an area including a downstream side of the upstream edge positions of the stator blades and not including a downstream side of positions where the stator blades have the largest width, in the axial direction.
